(19) United States
(12) Patent Application Publication
(10) Pub. No.: US 2008/0271067 A1
(43) Pub. Date: Oct. 30, 2008

(54) System and method for presenting advertising data

(75) Inventors: Zhi Li, San Ramon, CA (US); Raghvendre Savoor, Walnut Creek, CA (US)

Correspondence Address: GILBRETH ROEBUCK, PC, FROST BANK BUILDING, 6750 WEST LOOP SOUTH, SUITE 920, BELLAIRE, TX, 77401, US

(73) Assignee: ATT Knowledge Ventures L.P., Reno, NV (US)

(21) Appl. No.: 11/789,691

(22) Filed: Apr. 25, 2007

(51) Int. Cl. H04N 7/10

(52) U.S. Cl. 725/32

(57) ABSTRACT

A method for presenting advertising video data, the method including receiving at a first end user device, displayable data; scanning the displayable data for advertising selection data associated with the advertising data; and queuing the future video event for presenting data for the advertising based on the scheduling data. A data structure is disclosed for containing data embedded in a computer readable medium for providing a functional and structural interrelationship between a processor, the data structure and data stored in the data structure.

### FIELD OF THE DISCLOSURE

The present disclosure generally relates to the field of presenting targeted advertising data.

### BACKGROUND OF THE DISCLOSURE

Advertisers can potentially save advertisement dollars by targeting their advertisements rather than indiscriminately broadcasting their advertisements to a general population of recipients. Advertisement distributors and providers that enable a targeting advertisement model can correspondingly increase their revenue per advertisement impression by providing targeted advertisement options for advertisers.

Targeted advertisements have historically been sent to large targeted geographic areas such as a particular city, so that regional advertisers reach only those advertisement recipients who are deemed by the advertiser as most likely to be responsive to their advertisements.

### BRIEF DESCRIPTION OF THE DRAWINGS

FIG. 1 depicts an illustrative embodiment of a system for presenting advertising data in a particular illustrative embodiment;

FIG. 2 depicts a flow chart of functions performed in a particular method for presenting advertising data in another particular illustrative embodiment;

FIG. 3 depicts a data structure embedded in a computer readable medium as provided in an illustrative embodiment for providing a functional and spatial interrelationship between data in the data structure, the computer readable medium and a processor; and

FIG. 4 is an illustrative embodiment of a machine for performing functions disclosed in another illustrative embodiment for scheduling presenting advertising data in another particular illustrative embodiment.

### DETAILED DESCRIPTION

In a particular illustrative embodiment, advertising data (representing advertisements), is sent to selected end user devices. Each end user device receives advertising selection data in a video data stream indicating wherein the video data stream to insert the advertising data. By adjusting the advertising selection data, advertisers can select which advertisements or advertising data a particular end user will see. In one particular embodiment, the advertising selection data is a short excerpt of data extracted from the advertising data. The advertising selection data is used to select advertising data for presentation to a particular end user. In another particular illustrative embodiment, advertising selection data markers are generated from the advertising selection data and sent to end user devices where the markers are used to identify advertising data for presentation to an end user. In another particular illustrative embodiment, the advertising selection data are weighted to alter the order of priority in which advertising data are selected for presentation to on an end user device. In another particular illustrative embodiment, an end user device is prevented from skipping advertisements during presentation of advertising data.

In a particular illustrative embodiment a method for presenting advertising data is disclosed. The method includes receiving at a first end user device, displayable video data; scanning the displayable video data for advertising selection data associated with the advertising data; and presenting the advertising data at the end user device based on the advertising selection data. In another particular illustrative embodiment the advertising data, displayable data and advertising selection data are data selected from the group consisting of video, audio, image and text data. In another particular illustrative embodiment the advertising selection data are extracted from the advertising data. In another particular illustrative embodiment the advertising selection data further includes advertising selection marker data associated with advertising selection data in a database. In another particular illustrative embodiment the advertising selection marker data are received at the first end user device prior to receiving the displayable video data.

In another particular illustrative embodiment the advertising selection marker data further includes key word data selected from the group consisting of audio, video, text and image data. In another particular illustrative embodiment presenting further includes an act selected from the group consisting of displaying and sounding the advertising data on a second end user device, wherein the first end user device and the second end user device are different end user devices associated with an end user. In another particular illustrative embodiment the method further includes presenting the advertising data at a selected second end user device, wherein the selected second end user device is selected based on end user profile data wherein the first end user device and the second end user device are different devices selected from the group consisting of a set top box, cell phone, personal data assistant, web tablet, portable internet protocol device, personal computer and lap top computer.

In another particular illustrative embodiment the end user profile data indicates a second end user device based on a factor selected from the group consisting of end user location data, end user historical presenting history data, end user device selection data and end user device storage capacity data. In another particular illustrative embodiment the advertising marker data are received by a first selected end user device, wherein the first selected end user device is selected based on end user profile data indicating an end user preference for the advertising data. In another particular illustrative embodiment the method further includes selecting a second end user device for presenting the advertising data.

In a particular illustrative embodiment a method for sending advertising data to an end user device is disclosed. The method includes sending from an internet protocol television (IPTV) video server to a first end user device, displayable video data, wherein the displayable video data includes advertising selection data for selecting the advertising data for presenting the advertising data, wherein the advertising selection data further includes advertising selection marker data associated with the advertising selection data in a database. In another particular illustrative embodiment the advertising selection marker data are sent to the first end user device prior to sending the displayable video data based on end user profile data. In another particular illustrative embodiment the method further includes sending the advertising selection data to a selected second end user device, wherein the selected second end user device is selected based on end user profile data wherein the first end user device and the second end user device are different devices selected from the group consisting of a set top box, cell phone, personal data assistant, web tablet, portable internet protocol device, personal computer and lap top computer.

In a particular illustrative embodiment a computer readable medium containing a computer program useful for presenting advertising data is disclosed. The computer program includes instructions to receive at a first end user device, displayable video data; instructions to scan the displayable video data for advertising selection data for the advertising data; and instructions to queue the advertising data for presentation based on the advertising selection data.

In another particular illustrative embodiment a computer readable medium containing a computer program useful for sending advertising data to an end user device is disclosed. The computer program includes instructions to send from an internet protocol television (IPTV) video server to a first end user device, displayable video data, wherein the displayable video data excludes metadata and includes advertising selection data for the selecting advertising data for presenting wherein the advertising selection data further include advertising selection marker data associated with the advertising data in a database. In another particular illustrative embodiment the advertising selection marker data are sent to the first end user device prior to sending the displayable video data based on an end user profile.

In another particular illustrative embodiment a system for presenting advertising data is disclosed. The system includes a first end user device processor in data communication with a memory, the first end user device processor further comprising a first interface for receiving at a first end user device, displayable video data; and a computer program embedded in the memory. The computer program includes instructions to scan the displayable data for scheduling data for the advertising data and instructions to queue the future video event for presentation based on the scheduling data. In another particular illustrative embodiment the processor further includes a second interface for receiving advertising marker data associated with the advertising selection data in a data base, wherein the advertising marker data further includes key word data selected from the group consisting of audio, video, text and image data. In another particular illustrative embodiment the system further includes a second end user device processor in data communication with a memory. The second end user device processor includes a fourth interface for receiving the advertising data.

In a particular illustrative embodiment a system for sending video data to an end user device is disclosed. The system includes a processor at a video server in data communication with a memory. The processor further includes a first interface for sending from the video server to a first end user device, displayable video data, wherein the displayable video data includes advertising selection data for the future video event for presentation of the advertising data, wherein the scheduling data further includes advertising selection data associated with the advertising data in a database.

In another particular illustrative embodiment the advertising selection data are sent to the first end user device prior to sending the displayable data based on an end user profile. In another particular illustrative embodiment the system further includes a third interface for sending selected advertising data to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

In another particular illustrative embodiment a computer readable medium having a data structure embedded therein for storing data is disclosed. The data structure further includes a first field for containing data indicating displayable advertising selection data for selecting advertising data selected based on end user profile data. In another particular illustrative embodiment the data structure further includes a second field for containing data indicating displayable advertising selection marker data for including the advertising selection data in a database.

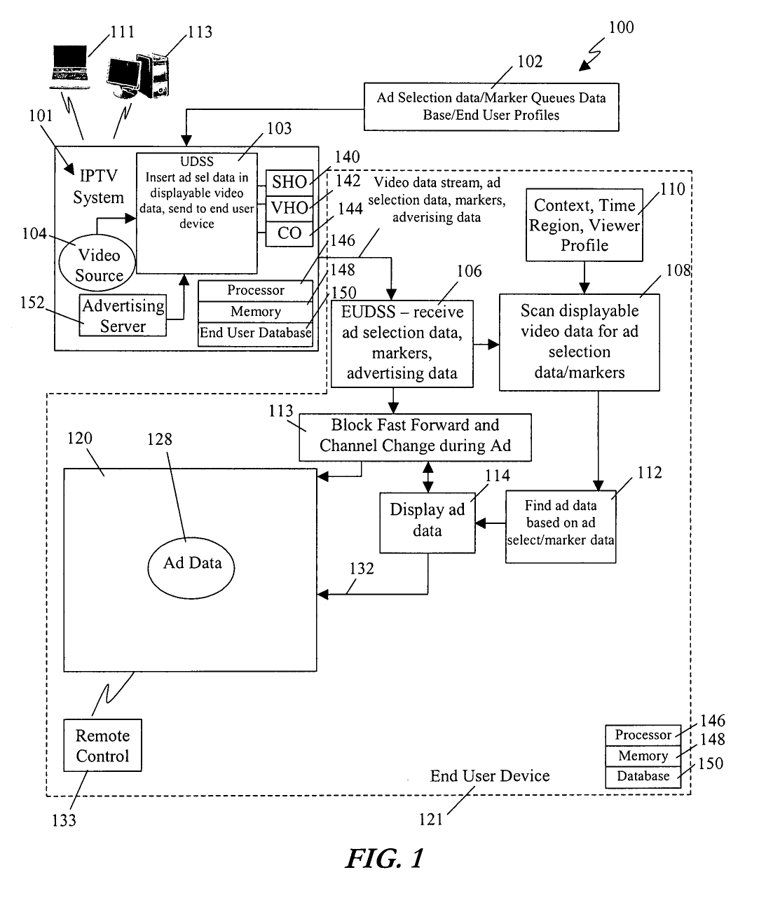

Turning now to FIG. 1, FIG. 1 depicts an illustrative embodiment of a television signal delivery system 100, including but not limited to an internet protocol television (IPTV) system 101 and an end user devices 121, 111 and 113 for receiving advertising data, advertising selection data and advertising selection data markers at an end user device. The IPTV system includes a hierarchically arranged network of IPTV servers that communicate over a digital communication network, and form a digital IPTV network. The IPTV network streams or distributes internet protocol (IP) video data from a super head end (SHO) server 140, to a video head end (VHO) server 142, to a central office (CO) server 144 to an end user device. In an illustrative embodiment, the SHO, VHO and CO communicate with each other using IP data communications transmitted over a high speed fiber optic cable system. In another illustrative embodiment, IPTV system communicates with an end user device using a fiber optic cable to a node, such as a service area interface (SAI) or digital subscriber line aggregator multiplexer (DSLAM) closest to the end user device or fiber optic cable to the premises in which the end user device is located. The IPTV system also includes wireless routers or other wireless communication devices that send wireless IP data to remote mobile devices 111 and 113 associated with an end user. In another particular illustrative embodiment, additional wireless networks in communication with the IPTV network can be utilized to facilitate wireless communication between the IPTV network and the remote mobile end user devices.

The IPTV system communicates or sends and receives wireless IP data to and from the mobile devices either directly or through other networks in data communication with the IPTV system. In an illustrative embodiment, the IPTV system includes IP data communication services for performing voice over internet protocol (VOIP) and internet service provider (ISP) data services for providing voice communications and internet data services to end user devices including but not limited to end user devices 121, 111 and 113. The IPTV system communicates with end user devices over data communication networks such as the internet or other available digital communication networks.

The IPTV system 101 includes but is not limited to an upstream data sensing system (UDSS) 103. The UDSS inserts advertising selection data into displayable video data. In either case, the advertising selection data is a short excerpt from advertising data that an advertiser wants an end user to view. Displayable video data includes that data such as content (video, audio, text and video data) in the video data stream that is presented visually or audibly to an end user, as opposed to metadata that is not presented visually or audibly to an end user. The displayable image, text, video and audio scheduling data are included in a displayable portion of the video data stream from IPTV video server 104. In another illustrative embodiment, the advertising selection data is inserted into metadata slots in an MPEG data stream.

The end user device 121 includes but is not limited to an end user data sensing system (EUDSS) 106. Thus, the IPTV system comprises a hierarchical network of servers (SHO, VHO, CO) that hierarchically distribute a video data stream. The IPTV video data stream can be an MPEG video data stream that includes displayable content including but not limited to video, audio, text and image data and non displayable metadata. For purposes of this disclosure the non displayable metadata is described as non displayable, since, the meta data is not intended for display, thus it is not displayable (or presentable) in the sense that it is not typically presented, displayed or sounded (used to create an audible signal), but is used to describe and provide auxiliary data to aid in the display of the displayable video data. In an alternative embodiment, the advertising selection data (which is displayable data) and advertising selection data markers can be stored in the metadata portions of an MPEG video data stream signal. The hierarchical IPTV network distributes the video data hierarchically to smaller geographic regions and associated servers (SHO to VHO to CO respectively) and finally to an end user devices 121, 111 and 113.

In a particular alternative embodiment, video data and advertising data received or intended to be received at a first end user device can be redirected to a second different end user device, through the IPTV system. In a particular illustrative embodiment, end users can be prevented from skipping advertising data presentation by disallowing fast forward and or channel switching commands during presentation of advertising data at an end user device.

The displayable video data includes audio, text video and image data that are presented to an end user, that is, during presentation, audio data is sounded and text, images and video data are displayed and/or sounded on an end user presentation device 120. The end user presentation device 120 includes but is not limited to a display and sound reproduction system, such as a loudspeaker or piezoelectric device. The SHO server delivers national video data (including image, video, text and audio data) content in the form of a television signal (e.g., an IPTV digital video data stream such as an MPEG 4 data stream) to regional VHO server, which redistributes the video data stream to sub regional CO servers. Each SHO, VHO, CO contain an advertising/video data server having a processor 146, computer readable medium (media) collectively referred to as memory 148 and database 150. End user devices 121, 111 and 113 contain an advertising/video data server having a processor 146, computer readable medium (media) collectively referred to as memory 148 and database 150. The UDSS 103 and EUDSS 106 sense scheduling data in the video data stream television signal having different data types. The UDSS can be associated with an SHO, VHO or CO for selection and insertion of advertising selection data and advertising selection marker data for distribution to particular end user devices.

In one particular illustrative embodiment, the EUDSS and/or UDSS compares the video data stream that makes up the television signal data to a queue of advertising selection data (advertising selection data queue) to sense the advertising selection data in the television signal. In a particular illustrative embodiment a UDSS then marks the advertising selection data with advertising selection marker data for sensing of the scheduling marker data at a down stream EUDSS. The advertising selection marker data is inserted in the displayable data for an MPEG data stream.

Metadata, as opposed to displayable data, is information about data including displayable video data, can be assigned to one of three categories. These categories include descriptive, administrative, and structural. Descriptive provides additional information for identification and exploration. Administrative supports resource management within a collection such as for indexing and accessing purposes. Structural provides information to bind together the components of more complex information objects. For example, in a graphical language, structural metadata may be used to determine how the objects from which a graphical image is to be rendered relate and interact. Alternatively, structural metadata can take the form of a set of instructions that when applied to one image, produce another image.

In another particular illustrative embodiment, the advertising selection marker data is inserted into metadata. In another particular illustrative embodiment, the EUDSS senses advertising selection marker data and associates the advertising selection marker data with advertising data in a database. In a particular illustrative embodiment, the advertising selection marker data are used as indices into advertising selection data. The advertising selection data are used as indices to advertising data in the data base to select advertising data associated with the advertising selection data. In another particular illustrative embodiment, the UDSS associated with an SHO, VHO or CO selects end user devices to receive and view particular advertising data that match the selected end users' interests and viewing habits based on the end users' profile data associated with a particular end user device. Each end user device can receive a separate advertising selection data queue advertising selection data so that individual end user device can receive a different advertising marker data queue and thus select and view different advertising data while viewing the same or different displayable content. Thus, an end user having an interest in sports based on viewing history, prior scheduled video events, purchasing history and phone call history as indicated in the end user's profile, will be sent advertising data or scheduling marker data queue for future video sporting events. Another end user having an interest in home and garden based on viewing history, prior scheduled video events, purchasing history and phone call history as indicated in the end user's profile, will be sent advertising selection data advertising home and garden to select home and gardening advertisement data for presentation during video programming.

Thus, in a particular embodiment, every end user is not sent the same advertising selection data. For example, if five advertising selection data (or corresponding marker data) (associated with five different advertisements or advertising data) appear in the video data stream, a first end user device may receive advertising selection data (or corresponding advertising selection marker data) for advertising data (advertisements) one, three and five and a second end user device may receive an advertising selection data or markers containing advertising selection data or markers for advertising data two and four. When the first end user device receives and senses advertising selection data or advertising selection data markers for advertising data one, three or five, the first end user device senses the advertising data marker as a member of its advertising selection data marker queue and displays advertising data associated with the advertising selection data marker.

The first end user device ignores the advertising data selection marker for advertising data markers two and four because these advertising selection data markers do not appear in the received advertising selection data marker queue for the first end user device. Similarly, when the second end user device receives an advertising selection data marker for advertising data two or four, the second end user device senses it as a member of its advertising selection data marker queue and presents advertising data associated with the sensed advertising selection data. The second end user device ignores advertising selection data marker for advertising data one, three and five because these markers do not appear in the received advertising selection data marker queue for the second end user device.

A video source 104 provides the video data stream, including displayable video data and metadata, which originates in the IPTV system. In a particular illustrative embodiment, the advertising selection data are excerpts of displayable advertising data extracted from the advertising selection data and sent to end user devices. Thus, when advertising selection data or advertising selection data markers are sensed in the video data stream, the advertising selection data can be compared to advertising data stored at the STB or another end user device. When the advertising selection data and advertising selection marker data queues are provided by the advertising server 152 and/or IPTV database 102. End user profiles data stored in the data base 102 and 150 are used by advertisers to decide on which end users will receive an advertising selection data marker for particular advertising data.

The advertising selection data and advertising selection data markers may be of different data types, including but not limited to video data, image data, text data and audio data. The advertising selection data can be audio key words such as “all around the world, ATT” or text, image or video key words such as the ATT logo. The EUDSS 106 senses or recognizes advertising selection data including but not limited to video data, image data, text data and audio data in the television signal or video data stream. In a particular illustrative embodiment, the incoming television signal is a digital video data stream, delivered from an IPTV system network of servers. In another particular illustrative embodiment, the television signal is a digital television video signal delivered over a broadcast cable system. In another particular illustrative embodiment, the television signal is an analog television signal delivered over a radio frequency antenna. In another particular illustrative embodiment, advertising selection data and advertising selection data markers including but not limited to video data, image data, text data, and audio data are sensed in the video data stream television signal by the EUDSS in the IPTV system. Thus, when an advertiser wants to target an advertisement to a particular end user, the advertiser uses or requests that the IPTV system excerpt a portion of the advertisement data for the advertisement and send to the excerpted portion of the advertisement data as an advertising selection data or advertising selection data marker associated with a the advertising selection data or advertising data to a particular end user.

The advertising selection data can be inserted into the television signal, e.g., overwritten into content or by inserting the advertising selection data in metadata in an MPEG video data stream or sent separately to an end user device. The advertising selection data can be sensed by a EUDSS 106 at an end user device 121 such as a set top box. In an illustrative embodiment, the advertising selection data is inserted into the displayable video content data. In another particular illustrative embodiment, the advertising selection data or advertising selection marker data is inserted into the metadata portions of the MPEG video data stream. In an illustrative embodiment, the video data stream is represented as an MPEG 4, MPEG 7 or later MPEG version data stream. The advertising selection data or advertising selection data marker may be associated with advertising data in the data base or may be an indicator for the EUDSS to look for data of a particular data type in the following video data within a particular time frame, for example, the first 1-2 seconds of advertising data.

In a particular embodiment, the advertising data, advertising selection data, and advertising selection data markers are sent to end user devices before sending displayable video data with which advertising data is to be presented. For purposes of this disclosure, displayable data also includes presentable data, that is, data that can be sounded (used to create audio sound) or displayed at an end user device.

In another particular embodiment, the end user devices 111 and 113 are a mobile Internet protocol (IP) devices including but not limited to a cell phone, personal data assistant or a web tablet. The advertising selection marker data is compared to scheduling data including video, audio, image and text data in the incoming television signal. In another particular illustrative embodiment, the advertising selection data is carried in metadata for the video data stream. Sensed advertising selection data and marker data are matched with advertising data in a database 150 at an end user device. End users can select which device 121, 111 or 113 at which the end user wishes to receive advertising data for presentation. Once advertising selection and/or marker data from a particular end user's advertising selection data or marker queue is sensed in a received video data stream, advertising data containing the extracted advertising selection data associated with the advertising selection marker data is selected from a data base for presentation. The advertising selection data is used to scan advertising data in the data base to select advertising data for presentation to an end user. The end user device selected for receipt of advertising data can be selected by the end user or selected by the method and apparatus based on an end user's current location, historical selection of presentation devices or an end user device which is currently actively in use by a particular end user. Historical presentation device selection data, currently active device data and addresses for each of an end user's end user devices are stored in a data structure discussed below.

The different advertising selection marker data queues can be assigned to different end users and distributed to end user devices based on correlation between advertising categories (sports, politics, etc.) end user profile data according to the data type, viewing history, program type, area of interest, geographic region, demographic (location, age, language, income, gender, purchase history, etc.) and according to a tendency to respond to a particular data type of an end user or an end user's demographic. Each end user's historical response to a particular advertising data type is recorded and stored at the end user device. A tendency for each end user to respond to a particular advertising data type is determined from the recorded responses and used to determine a tendency of an end user to respond to the data type. Weights are assigned to data types based on the user's response tendency each data type (image, video, audio, text). These tendencies are reported to the IPTV system servers for use by advertisers in directing advertising data and advertising selection marker data queues to particular end users and the end users' demographic groups.

Weighting data for each end user and each end user demographic group can be stored at the IPTV server and used to weight advertising selection marker data queues to demographic groups of end users and individual end users. Additional criteria stored in an end user profile, including but not limited to Internet or eCommerce purchasing history, internet surfing activity, etc. can be used to weight scheduling data and scheduling marker data queue elements. Advertising selection data in the queue are weighted more heavily and favored over data with less weight. Historical advertising data viewing habits for an end user are stored in the end user profile along with purchase history, demographic data, location, income, etc. and used by advertisers in selecting which programs advertised as future video events and which end users receive a scheduling marker for the future video event in their scheduling marker data queue. In one particular illustrative embodiment, an advertising selection marker data queue includes but is not limited to a list of one or more advertising selection marker data (also referred to herein as “queue elements” or “elements”).

In a particular illustrative embodiment the weighting data that may be included is a set of weights assigning data type weights, response tendency weights, viewer profile weight, future video event category, and/or regional weights. In another particular embodiment the weighting data includes weighted reference data, which is used to favor selection of scheduling marker data and scheduling data sensed by the EUDSS or UDSS. Thus the weighted marker data will be favored or weighted more heavily than other advertising selection data. For example if a particular end user or a demographic for a particular end user has a tendency to respond more to text data than audio data, then sensed advertising selection or marker data associated with advertising text data will be weighted more heavily than sensed marker data associated with advertising audio data. Regional weighted marker data can be sent to favor different scheduling marker data to favor different advertising data in different regions. Thus the same advertising selection data or marker data queue can be sent to different regions and the weighting data can be used to favor different scheduling marker data queue elements in different regions. Thus, weighting can be used to select a top five out of ten queue elements for advertising data to be selected in each region, which may vary by region. In another alternative embodiment, the weighting data can be altered by an end user profile. In another illustrative embodiment, different alternative data can be sent to different regions or different end users. In a particular illustrative embodiment, the same advertising seleciton data queue can be sent to three end users but different weighting data can be sent to each of the three end users so that each end user selects a different top five out of ten advertising selection data or advertising selection marker data queue elements for sensing and display of advertising data.

Similarly, if an end user is in a particular demographic group with a known response to a particular advertising data type or a particular end user has a tendency to respond more to video or image data than text data in advertising data, then advertising selection and marker data for the sensed advertising selection data and advertising selection data marker video or image data will be weighted more heavily than sensed text data for the particular end user or demographic group of end users. In another particular illustrative embodiment, each end user device receives the same list of advertising marker queue data and a different list of advertising selection data based on their end user profile. The advertising selection and or weighting data may include regional weighting for advertising data for businesses near the end user device location, names of foods or celebrities that appeal to a demographic group with which the end user is associated based on the data stored in the end user profile stating location and demographic group for the end user.

Advertising selection data and advertising selection marker data can be supplied to the UDSS 103 or the EUDSS 106 by an advertising server 152 from the IPTV system general database 103 or by an advertiser reference data database 102. The advertising selection data and advertising selection marker data queues can contain video data, image data, audio data, and text data, extracted from advertising data, which can be used for indexing into advertising data for selection presentation on an end user device. The advertising selection data can also be marked by the UDSS so that less processing power is required to sense scheduling data at the EUDSS, since the EUDSS would only have to look for advertising selection markers data (video, audio, text, image) rather that performing full sensing (video, audio, text, image) of advertising selection data including but not limited to speech recognition, pattern recognition, and image recognition.

The advertiser or user can select advertising data for particular regions, data types and demographics by selecting weighting data or advertising selection data for insertion into the television signal or downloading to an end user device from the IPTV network SHO, VHO or CO. Each advertising selection data can have a particular weight assigned in the database and can be used to weight scheduling data. Keywords for text, image, video and audio scheduling data comprise image or video data such as audio or text phrases associated with scheduling data in a data base or a video stream can be weighted by the weighting data for selecting and prioritizing an advertising selection data queue.

In an illustrative embodiment the data sensing devices (UDSS and EUDSS) sense or recognize advertising selection data and advertising selection marker data in the video data stream. In a particular illustrative embodiment, the sensed advertising selection data can be replaced at the IPTV server with advertising selection marker data and sent to the EUDSS where the advertising selection marker data are associated with appropriate advertising selection data and advertising data for presentation. The advertising selection marker data can be used as an index into the database 150 for associating the marker with advertising data. In one particular illustrative embodiment, the audio and text passages, included in advertising selection data can include but are not limited to video, image, text and audio key words that are identified using pattern recognition, image recognition, speech recognition and text recognition techniques.

In a particular illustrative embodiment, default weighting data for advertising data type weight is assigned on a scale of 10, for audio data=7, video/image data=5, and text data=3. A default weighting data for event category weight is assigned on a scale of 10, for sports data=7, politics data=5, and fashion data=3. Those weights can be adjusted by weighting the reference data downloaded to the end user device. Additional weight is assigned to keywords (e.g., football, Corvette, Wild at Heart) in the same category (e.g., sports, politics, cars, movies, etc.) appearing in more than one data type at substantially the same time (e.g., within 2 seconds). Thus if the image of a football and the phase “football team” which are in the same category, i.e., sports, are sensed in the television signal at the same or close to the same time, additional weight is assigned to the advertising selection data “football team.”

The advertising selection data keywords can also be weighted by the context, which includes time of day, geographic region and current viewer profile, response tendency, demographic, which is provided by system 110. Thus the advertising selection key word data (audio, image, text or video) for “foot ball team”, i.e., “Dallas Cowboys” can be assigned more weight in Texas than Washington, D.C. A different alternative data item for football team, i.e., “Washington Redskins” can be assigned more weight in Washington, D.C. The keywords, which are weighted according to the inputs in block 108, are sent to system 112 where the alternative data are weighted.

In an illustrative embodiment the EUDSS 106 receives input from an end user remote control 133. The EUDSS also senses reference data in the stored advertising data. The key words include image, text, audio and video data. A context is recorded in system function block 110 wherein the processor records time of day, viewer profile, programs viewed, and region associated with the selected advertising data.

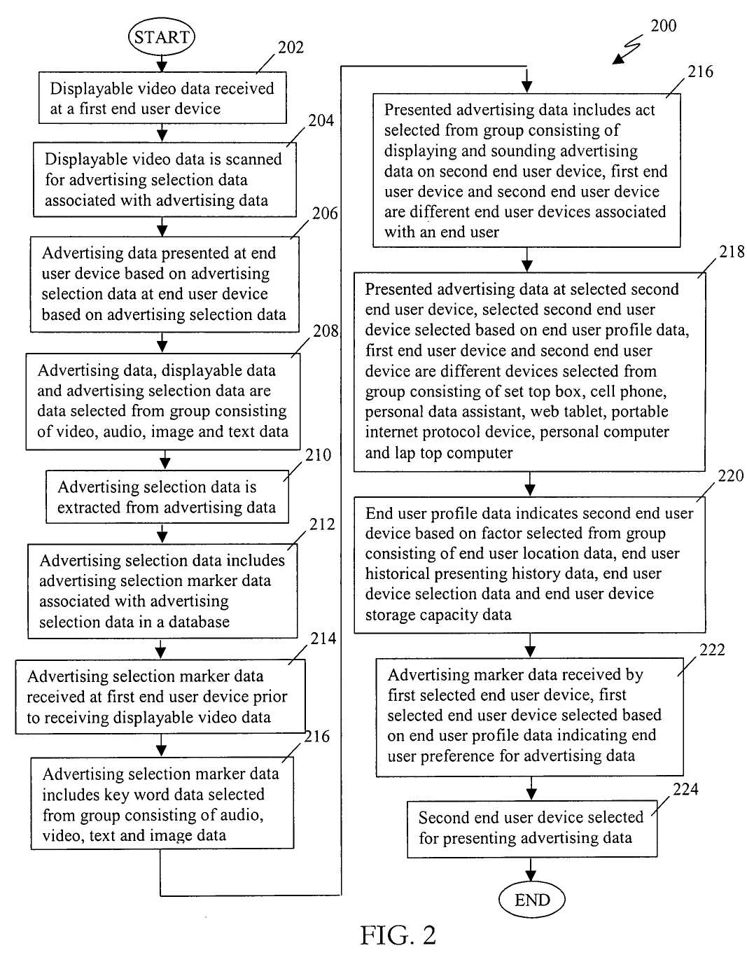

Turning now to FIG. 2 in an illustrative embodiment a series of functions performed by a software agent or software program component of computer readable instructions executed by an illustrative system processor are performed to present advertising data. Displayable video data is received at a first end user device at block 202. Displayable video data is scanned for advertising selection data associated with the advertising data at block 204. Advertising data is presented at the end user device based on the advertising selection data at the end user device based on the advertising selection data at block 206. Advertising data, displayable data and advertising selection data are data selected from the group consisting of video, audio, image and text data at block 208. Advertising selection data is extracted from the advertising data at block 210. Advertising selection data includes advertising marker data associated with the preloaded advertising data in a database at block 212. Advertising marker data is received at the first end user device prior to receiving displayable video data at block 214. Scheduled marker data includes keyword data selected from the group consisting of audio, video, text and image data at block 216. Advertising data presented includes an act selected from the group consisting of displaying and sounding advertising data on the second end user device, the first end user device and the second end user device are different end user devices associated with an end user at block 216. Advertising data presented at selected second end user device, selected second end user device is selected based on end user profile data, the first end user device and the second end user device are different devices selected from the group consisting of set top box, cell phone, personal data assistance, web tablet, portable internet protocol device, personal computer and lap top computer at block 218. End user profile data indicates the second end user device is based on factor selected from the group consisting of the end user location data, the end user historical presenting history data, the end user device selection data and the end user device storage capacity data at block 220. Advertising marker data is received by the first selected end user device, the first selected end user device is selected based on the end user profile data indicating the end user preference for the advertising data at block 222. The second end user device is selected for presenting the advertising data at block 224.

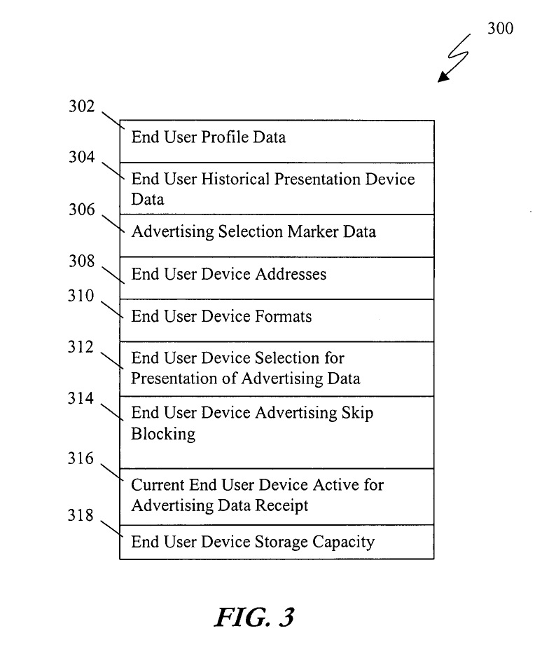

Turning now to FIG. 3, in a particular illustrative embodiment a data structure 300 embedded in a computer readable medium for providing a structural and functional interrelationship between the data in the data structure and a processor, processor software or method for presenting data related to an end user profile data. The data structure 300 includes fields for storing data used by an illustrative embodiment of a system and method. In data structure field 302 an end user profile data field is illustrated for storing data indicative of end user profile data. In data structure field 304 an end user historical presentation device data field is illustrated for storing data indicative of end user historical presentation device data. The historical present device data indicates which end user device associated with the end user indicated in the end user profile will receive advertising data, advertising selection data and advertising selection data markers. In data structure field 306 an advertising selection data marker field is illustrated for storing data indicative of advertising selection data marker data. In data structure field 308, an end user device addresses field is illustrated for storing data indicative of end user device addresses for end user devices associated with an end user indicated in the end user profile.

In data structure field 310, an end user device formats field is illustrated for storing data indicative of end user device formats. When an end user device is sent advertising data, the advertising data may be formatted according to the field 310. In data structure field 312, an end user device selection for presentation field is illustrated for storing data indicative of end user device selection for presentation of advertising data. In data structure field 314 an advertising skip blocking field is illustrated for storing data indicating that commercial skipping is prohibited during a particular advertising data presentation. In data structure field 316 a current end user device active for advertising data receipt field is illustrated for containing data indicating an end user device which is currently being used by an end user so that advertising data, advertising selection data and advertising selection data markers can be directed to the currently active end user device. In data structure field 318 a device storage capacity field is illustrated for containing data indicating end user device storage capacity for storing advertising data at each end user device associated with an end user indicated in the end user profile data.

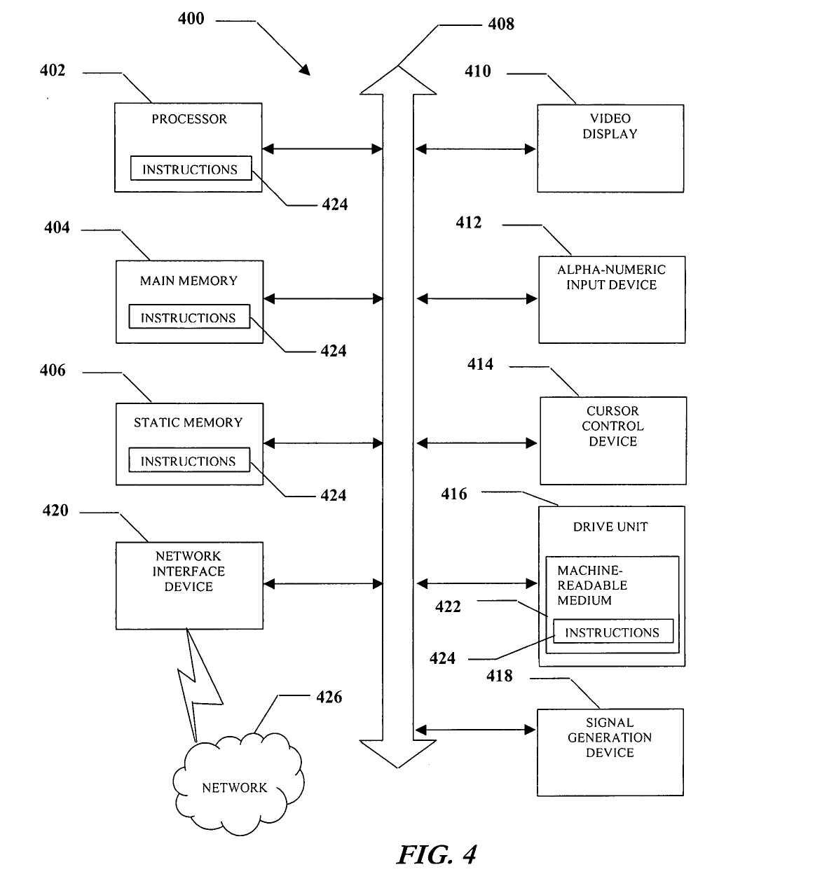

FIG. 4 is a diagrammatic representation of a machine in the form of a computer system 400 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., liquid crystals display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420. The machine readable medium may also contain a data structure for containing data useful in providing a functional relationship between the data and a machine or computer in an illustrative embodiment of the disclosed system and method.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for presenting advertising data comprising:
receiving at a first end user device, displayable video data;
scanning the displayable video data for advertising selection data associated with the advertising data; and
presenting the advertising data at the end user device based on the advertising selection data.

2. The method of claim 1, wherein the advertising data, displayable data and advertising selection data are data selected from the group consisting of video, audio, image and text data.

3. The method of claim 2, wherein the advertising selection data are extracted from the advertising data.

4. The method of claim 1, wherein the advertising selection data further comprise advertising selection marker data associated with advertising selection data in a database.

5. The method of claim 4, wherein the advertising selection marker data are received at the first end user device prior to receiving the displayable video data.

6. The method of claim 4, wherein the advertising selection marker data further comprise key word data selected from the group consisting of audio, video, text and image data.

7. The method of 1, wherein presenting further comprises an act selected from the group consisting of displaying and sounding the advertising data on a second end user device, wherein the first end user device and the second end user device are different end user devices associated with an end user.

8. The method of claim 1, further comprising:
presenting the advertising data at a selected second end user device, wherein the selected second end user device is selected based on end user profile data wherein the first end user device and the second end user device are different devices selected from the group consisting of a set top box, cell phone, personal data assistant, web tablet, portable internet protocol device, personal computer and lap top computer.

9. The method of claim 8, wherein the end user profile data indicates a second end user device based on a factor selected from the group consisting of end user location data, end user historical presenting history data, end user device selection data and end user device storage capacity data.

10. The method of claim 4, wherein the advertising marker data are received by a first selected end user device, wherein the first selected end user device is selected based on end user profile data indicating an end user preference for the advertising data.

11. The method of claim 1, further comprising:
selecting a second end user device for presenting the advertising data.

12. A method for sending advertising data to an end user device, comprising:
sending from an internet protocol television (IPTV) video server to a first end user device, displayable video data, wherein the displayable video data includes advertising selection data for selecting the advertising data for presenting the advertising data, wherein the advertising selection data further comprise advertising selection marker data associated with the advertising selection data in a data base.

13. The method of claim 12, wherein the advertising selection marker data are sent to the first end user device prior to sending the displayable video data based on end user profile data.

14. The method of claim 12, further comprising:
sending the advertising selection data to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

15. A computer readable medium containing a computer program useful for presenting advertising data, the computer program comprising:
instructions to receive at a first end user device, displayable video data;
instructions to scan the displayable video data for advertising selection data for the advertising data; and
instructions to queue the advertising data for presentation based on the advertising selection data.

16. A computer readable medium containing a computer program useful for sending advertising data to an end user device, the computer program comprising:
instructions to send from an internet protocol television (IPTV) video server to a first end user device, displayable video data, wherein the displayable video data excludes metadata and includes advertising selection data for the selecting advertising data for presenting wherein the advertising selection data further comprise advertising selection marker data associated with the advertising data in a data base.

17. The medium of claim 16, wherein the advertising selection marker data are sent to the first end user device prior to sending the displayable video data based on an end user profile.

18. A system for presenting advertising data comprising:
a first end user device processor in data communication with a memory, the first end user device processor further comprising a first interface for receiving at a first end user device, displayable video data; and
a computer program embedded in the memory, the computer program comprising instructions to scan the displayable data for scheduling data for the advertising data and instructions to queue the future video event for presentation based on the scheduling data.

19. The system of claim 18, the processor further comprising:
a second interface for receiving advertising marker data associated with the advertising selection data in a data base, wherein the advertising marker data further comprise key word data selected from the group consisting of audio, video, text and image data.

19. The system of claim 17, further comprising:
a second end user device processor in data communication with a memory, the second end user device processor comprising:
a fourth interface for receiving the advertising data.

20. A system for sending video data to an end user device, comprising:
a processor at a video server in data communication with a memory, the processor further comprising:
a first interface for sending from the video server to a first end user device, displayable video data, wherein the displayable video data includes advertising selection data for the future video event for presentation of the advertising data, wherein the scheduling data further comprises advertising selection data associated with the advertising data in a data base.

21. The system of claim 20, wherein the advertising selection data are sent to the first end user device prior to sending the displayable data based on an end user profile.

22. The system of claim 20, further comprising:
a third interface for sending selected advertising data to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

23. A computer readable medium having a data structure embedded therein for storing data, the data structure further comprising:
a first field for containing data indicating displayable advertising selection data for selecting advertising data selected based on end user profile data.

24. The medium of claim 23, the data structure further comprising:
a second field for containing data indicating displayable advertising selection data marker data for including the advertising selection data in a database.

25. The medium of claim 23, the data structure further comprising:
a third field for containing data indicating an end user device storage capacity for an end user device for determining whether the end user device can store data for the advertising data.
